(19) United States
(12) Patent Application Publication
(10) Pub. No.: US 2008/0103720 A1
(43) Pub. Date: May 1, 2008

(54) Method and system for providing storage and retrieval of clinical information

(75) Inventors: Peter M. White, Dallas, TX (US); Thomas P. White, Dallas, TX (US)

Correspondence Address: LAW OFFICE OF DAVID H. JUDSON, 15950 DALLAS PARKWAY, SUITE 225, DALLAS, TX, 75248, US

(73) Assignee: Vocada, Inc.

(21) Appl. No.: 11/586,360

(22) Filed: Oct. 25, 2006

(51) Int. Cl. G06F 19/00; G06F 17/40; G08B 23/00

(52) U.S. Cl. 702/127; 702/1; 702/187; 340/870.01; 340/870.16; 340/500; 340/501; 340/502; 340/540

(57) ABSTRACT

The present invention provides a managed or “hosted” service offering that facilitates timely and accurate communication of clinical information, such as critical test results, within a health care environment. The inventive system enables pathologists, laboratory technicians, and laboratory staff to communicate to ordering physicians clinical information (such as lab results) in real-time via a traceable and verifiable communication system. According to the invention, a recipient of the clinical test results is prompted to verify the test results that he or she has just heard to confirm receipt of such results, as well as confirmation that the information provided was properly understood. The read back function ensures that the actual communication of complete clinical information (such as critical tests results) occurs in a seamless, real-time manner.

This application includes subject matter protected by copyright.

### BACKGROUND OF THE INVENTION

1. Technical Field

The present invention relates generally to methods and systems for managing clinical information, such as critical test results, in a health care environment.

2. Description of the Related Art

Critical test results, especially when emerging from ancillary services within a health care environment such as Pathology and Radiology, are subject to systematic errors in part because of the large numbers of tests that are ordered and relative infrequency of urgent results that require immediate attention, as well as the lack of direct consultation in the ordering of such studies.

The importance of effective communication as it relates to patient safety is an inherent component of health care delivery. Federal regulations applying to Clinical Laboratories expressly state (Section 493.1234, subpart K, Quality Systems for non waived testing, Department of Health and Human Services, Centers for Disease Control and Prevention) “[a] laboratory must have a system in place to identify and document problems that occur as a result of a breakdown in communication between the laboratory and an authorized individual who orders or receives test results.”

Response to such directives in the laboratory and radiology community has been inconsistent, especially at the local level. Recently, from a national perspective, The American College of Radiology revised its Guidelines on Communication in 2005 to reflect the need for direct communication where findings suggest the need for immediate medical intervention, where conclusions differ in substance from prior interpretations, where findings suggest a condition that is likely to worsen over time if not promptly addressed, and where findings are unclear and follow-up is required. The Clinical Laboratory community's response at a national level has been less specific.

Attention to the importance of both the transmitting and receiving of critical test results has been the subject of initiatives around the country. The Pennsylvania Patient Safety Authority was established as a state legislative remedy aimed at an improved monitoring and reporting system. The Massachusetts Coalition for the Prevention of Medical Errors has advanced the concept of stratifying degrees of severity of results so that clinicians can receive such information and act on it in a deliberate manner commensurate with the urgency of the situation. Clearly, in the medical field, given the gaps in communication that can directly impact patient care in a negative sense, the adage “no news is good news” is no longer a viable position.

Because non-primary care, ancillary services such as Pathology (clinical laboratories, anatomic specimens, toxicology, etc) and Radiology issue large numbers of test results and the services are usually requested with little personal interface among health care providers, shortcomings beyond individual physician competencies comprise enterprise issues. It therefore follows that maintenance of quality and efficacy invite system solutions, especially as they relate to the communications of abnormal results. Prior efforts have attended to these directives, but have been underutilized, resource intensive, and even misdirected. This result is in part due to of the historical absence of methodologies suited to respond appropriately to different circumstances and in part due to a lack of an enterprise-wide solution which is the natural solution to system-oriented problems.

It is also known in the prior art to provide third party hosted or managed services whereby reporting clinicians use a computer-based telephony system to communicate clinical information to an ordering physician. One such system, formerly known as VoiceLink™ from Vocada, Inc. of Dallas, Tex., is operated as a managed service. Using this system, an ordering physician can designate a primary contact (e.g., fax, email, or the like) to which he or she desires to be notified of clinical information, such as critical test results, as well as one or more backup contacts. After a clinical test, a reporting clinician creates a message by calling into the service and entering given information, typically via a combination of keypad entries and spoken words, which includes test result data. The system then attempts to deliver the message to the ordering physician using the designated contact information. The system also includes various alerting, reporting and management functions.

While managed services such as described above provide numerous advantages, there remains a need in the art to enhance such systems to provide additional for the timely and efficient communication of clinical test results data.

The present invention addresses this need.

### BRIEF SUMMARY OF THE INVENTION

The present invention enables pathologists, laboratory technicians, and laboratory staff to communicate lab or other results to ordering physicians and others in real-time using a traceable and verifiable communication system.

In particular, a communication system is provided, preferably as a third party managed or hosted service, that enables laboratory clinicians to easily create intelligent messages that contain lab results, and the system further provides the ability to enable given persons to send those results to other interested persons (such as ordering physicians and nursing staff) within a health care facility.

An embodiment of the invention is a method operative in a computer system that provides a hosted service. The method is used to communicate given clinical information, such as critical test result data. The method begins by having a first entity (such as a laboratory clinician) generate a message comprising an identifier associated with at least a second entity (such as a shift nurse), together with at least one result associated with a given clinical test. The message is sometimes referred to herein as a “laboratory results message.” The service then automatically notifies the second entity of the message. The notification may be in the form of an email, an SMS, a telephone call, a page, a desktop alert, or the like. When the second entity contacts the service, the message (which includes the result) preferably is provided to the second entity. According to the method, the second entity is then prompted to verify the result that has just been provided, preferably by requesting that the second entity provide back the result using an input device (such as a keypad, spoken input, an application interface, or the like). Upon confirmation that the second entity has provided the result accurately, the system notifies the first entity that the second entity has verified proper receipt of the result. Because the result has been presented and verified by the second entity, the system then enables the second entity to take a further action, such as communicating the message to a third entity (e.g., an ordering physician). If the system cannot confirm that the second entity knows the result (e.g., because the second entity has not provided the result, or has provided an incorrect value), the system notifies the first entity of this read-back discrepancy and preferably inhibits the second entity from take the further action. In this manner, the data value (which may be a critical test result) is veriflably communicated to the interested persons in a traceable manner.

Thus, to provide a more concrete example, a laboratory clinician logs into a service application, which application may be accessible over a secure computer network using an application. The application allows the lab clinician to specify given information, such as: one of more recipients of given lab test results, the name of the patient, an identifier (such as a medical record number (MRN) or the like), the ability to categorize the message based on the severity of finding, and the ability to specify an actual lab result, for example, “Potassium 6 milli-equivalents per liter (mEq/L)”. In addition, the lab clinician can specify whether the test result requires an active “read back” of a measured value, such as the potassium level in the above example. Using the system, the laboratory clinician may also create an additional voice note that is then appended to the overall message. Once created, the result is sent to a nurse based on the nurse's communication preferences. Thus, for example, a notification sent to a nurse's notification application (e.g., a pager) might state “Red CTR—High Potassium for MRN 654321. Please call 1-866-555-1212 and enter access code 123456 to retrieve and verify message.” When the nurse calls back into the system, he or she enters the access code is presented with an audio message of the lab result. As an example, the audio message might state: “you have a Red Critical Test Result from Baylor Laboratory for patient John Smith, MRN. The test result is Potassium High: 6 mEq/L. That's 6 mEq/L. Using your telephone keypad, please verify the result by entering the mEq.” The nurse then enters “6” on his or her keypad and hears: “you have confirmed Potassium 6 mEq/L. Thank you for using the system.” The system then reports the confirmation back to the laboratory clinician and enables the nurse to forward the message, e.g., to an ordering physician. If, however, the nurse enters the wrong information in response to the prompt, an error message is played. Thus, according to the invention, a recipient of the clinical test results is prompted to verify the test results that he or she has just heard (or seen) to confirm receipt of such results, as well as confirmation that the information provided was understood.

Preferably, messages that are not retrieved within a specified time period are subject to system escalation rules. Any read-back discrepancies preferably are immediately sent to a reporting clinician, a reporting department, and to a hospital patient safety coordinator. Dynamic and periodic reports can be generated to determine read-back, reporting, and turnaround time compliance.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

FIG. 1 is a block diagram of a service provider infrastructure for implementing a technology platform according to the present invention;

FIG. 2 is a more detailed block diagram of an integrated voice and data messaging hosted service for use in the present invention;

FIG. 3 illustrates a representative personal computer for providing a voice entry interface for use by a clinician to create a laboratory results message;

FIG. 4 illustrates a representative interface message tab for entry of critical test result data and an accompanying voice note according to one aspect of the present invention;

FIG. 5 illustrates a representative interface tab for entry of multiple test results;

FIG. 6 illustrates the message tab of FIG. 4 after entry of the multiple test results using the interface tab of FIG. 5;

FIG. 7 illustrates a preferred workflow for a message delivery and forwarding routine of the present invention.

### DETAILED DESCRIPTION OF THE PREFERRED EMBODIMENT

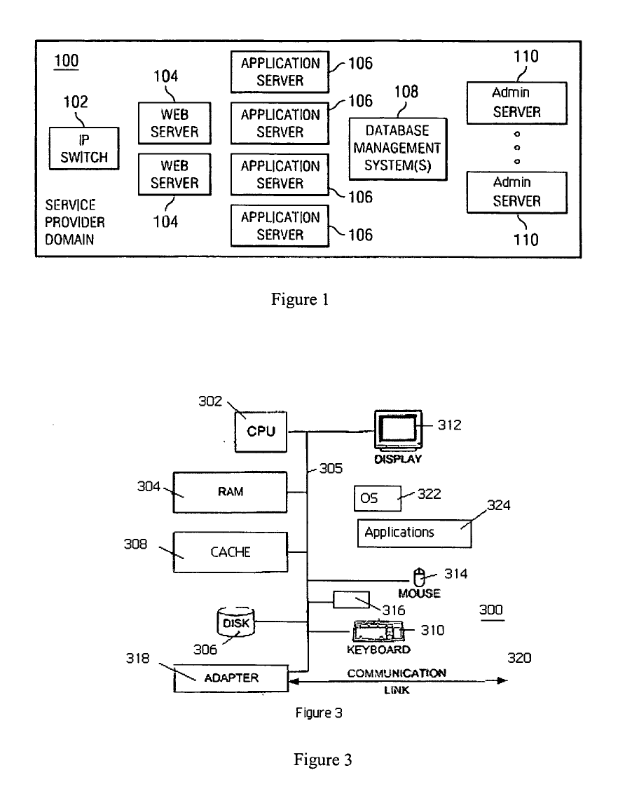

FIG. 1 illustrates a representative service provider or system architecture, which in the preferred embodiment is implemented in or across one or more data centers. A data center typically has connectivity to the Internet. In one embodiment, the system provides a web-based hosted solution for use in a health care environment (e.g., a hospital, a clinic, a physician's office, or the like) through which users (as described below) to create and track medical communications. The health care environment typically comprises voice and data systems, machines, devices and infrastructure. Participants interact with the platform using conventional technologies such as telephones, mobile devices, personal computers, personal digital assistants, and the like. The system may be implemented within a single facility or across multiple facilities. Typically, to secure data and protect privacy the system is implemented over a private network, although this is not a requirement.

Thus, for example, a user of the system has a machine such as a workstation, notebook computer, personal digital assistant, mobile device, or the like. Typically, a user accesses the service provider architecture by calling a given telephone number, by opening a web browser on the machine to a URL associated with a service provider domain or sub-domain, or the like. Telephony subsystems may use voice-over-IP technologies to integrate with data systems. The user then authenticates to the managed service in the usual manner, e.g., by entry of a username and password. The connection between the business entity machine and the service provider infrastructure may be encrypted or otherwise secure, e.g., via SSL, or the like. Although connectivity via the publicly-routed Internet is typical, the entity may connect to the service provider infrastructure over any local area, wide area, wireless, wired, private or other dedicated network. As seen in FIG. 1, the service provider architecture 100 comprises an IP switch 102, a set of one or more web server machines 104, a set of one more application server machines 106, a database management system 108, and a set of one or more administration server machines 110. A representative web server machine 104 comprises commodity hardware (e.g., Intel- or AMD-based), an operating system such as Windows (or Linux), and a web server such as Microsoft IIS (or Apache). A representative application server machine 106 comprises commodity hardware, Microsoft Windows, and an application server such as Microsoft NET 1.1 (or WebLogic). The database management system 108 may be implemented as a SQL Server (or Oracle) database management package. In a high volume use environment, there may be several web server machines, several application server machines, and a number of administrative server machines. Although not shown in detail, the infrastructure may include a name service, other load balancing appliances, other switches, network attached storage, and the like. The system typically will also include connectivity to external data sources, such as third party databases that provide historical data. Each machine in the system typically comprises sufficient disk and memory, as well as input and output devices. Generally, the web servers 104 handle incoming business entity provisioning requests, and they export a display interface. The application servers 106 manage the data and facilitate the functions of the platform. The administrator servers 110 handle all back-end accounting and reporting functions. The particular hardware and software implementation details described herein are merely for illustrative purposes are not meant to limit the scope of the present invention.

In a representative system, the primary users include: a reporting clinician (e.g., radiologists, pathologists, laboratory clinicians and other health care providers who have a need to report critical test results), nurses and nurse practitioners, and ordering physicians (i.e., persons who place orders for various tests including x-rays, blood samples, and the like, and who receive the results from the reporting clinician). In one embodiment, the hosted service in implemented using a communication system, such as the system formerly known as VoiceLink™ from Vocada, Inc. of Dallas, Tex., which is operated as a managed service. Such a system enables reporting clinicians to communicate clinical information to an ordering physician. Such information may include, without limitation, so-called critical test results.” As described above, a critical test result is a test result that might have an immediate impact on the patient's care. Using this type of communication system or an equivalent, an ordering physician or nurse can designate a primary contact mechanism (e.g., fax, email, SMS, MMS, computer-based alert, or the like) by which he or she desires to be notified of critical test results, as well as one or more backup contacts. A system administrator manages the service on behalf of the business entity.

The following Table I identifies the various actors who typically use the system and their typical roles:

TABLE I

| Actor | Description |
|---|---|
| Reporting Clinician | A Lab technician that is creating the message based on critical lab |
| (RC) | results. |
| Ordering Clinician | A physician or ordering clinician who ordered the test for |
| (OC) | the patient and who ultimately receives the critical result message, |
| | either directly or via the Shift Nurse |
| Charge Nurse | A nurse in charge of the unit or nursing station and |
| (monitor) | responsible for the room/bed/patient who had the test that |
| | resulted in critical result. |
| Shift Nurse | A nurse who will be receiving the message directly from |
| | the Lab to a communication device - cell phone, pager, or the like |
| System Monitor | A person responsible for monitoring messages sent to one |
| | or more units. This person preferably will have access to |
| | the message monitoring tab and be allowed to forward a |
| | message, but preferably he or she cannot create messages |
| | or enter shift assignments. Preferably, only a Message list tab will be |
| | visible to this user. |
| System | A person responsible for entering new profiles, user |
| Administrator | information, hospital information, and directory entries. |

FIG. 2 is a more detailed illustration of a hosted service architecture 200 in which the present invention may be implemented. The invention may also be implemented in other such systems having similar devices and processes. In one embodiment, the hosted service comprises a set of software processes or modules that preferably execute in a given hardware and software execution environment, such as commodity machines running Microsoft Windows, and Microsoft Internet Information Server (IIS) that has NET 1.1 support. These processes include, for example, a Notifier process 202, which is used to provide a Web Services-based notification service 204, a GUI process 204, which provides a user display interface for radiologists and administrators, a GUI 206, which provides a user display interface for referring physicians, a Report process 208 that generates reports of service activity, a Database interface 210, which facilitates service provider support, a Web Service API 212, which facilitates communications to external systems, and a Console Application 214, which facilitates private (e.g., VPN) connections to health system (e.g., hospital) systems. Voice interactivity is facilitated using a Java Virtual Machine (JVM) 216 that provides a voice user interface 218 and an outbound telephony notifier 220. The illustrated processes communicate and exchange data (preferably over the Internet) with various systems and entities (e.g., email servers, gateways, users, external systems, customer systems) such as shown on the left-hand portion of the diagram, as well as with the database systems 222 (sometimes referred to as Admin herein) such on the right-hand portion of the diagram. Of course, this architecture is merely representative.

Information is input to the hosted service in any of a number of ways. As noted above, FIG. 2 illustrates different processes including, without limitation, a Web Services interface, a GUI, a voice entry interface, and the like, by which a user (a person or an automated process) enters information or data for use in the laboratory results message. In addition, a person or entity is notified concerning the message in any number of convenient ways, e.g., by email, fax, SMS, MMS, page, call, application alert, or the like. Moreover, as will be seen, a recipient of a message preferably responds to a prompt concerning the message in any convenient manner as well, e.g., by voice input, key input, email, SMS, MMS, application data entry, or the like.

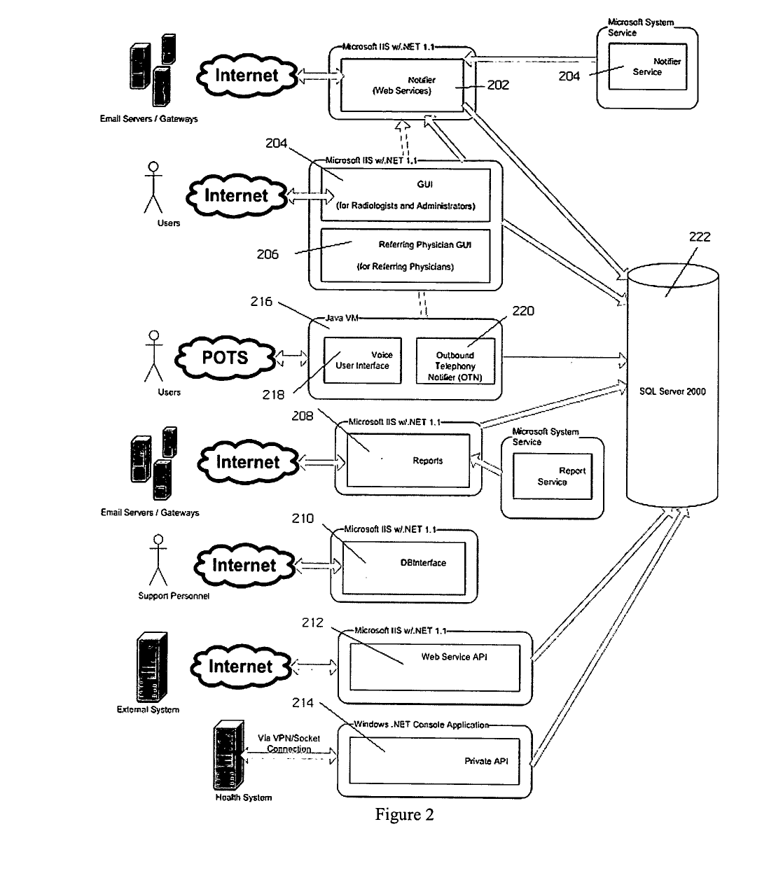

In a representative (but non-limiting) embodiment, a Reporting Clinician (RC) enters critical test result data into the system using a personal computer keyboard or pointing device, together with a microphone attached to the user's computer. FIG. 3 is a representative computer system for this purpose. A computer or data processing system 300 includes processor 302 coupled to memory elements through a system bus 305. The memory elements include local memory 304 employed during actual execution of the program code, disk storage 306, as well as cache memory 308 that provides temporary storage of program code and data. Input/output devices, such as a keyboard 310, a display 312, a pointing device 314, a microphone 316, and the like, are coupled to the system either directly or through intervening I/O adapters or controllers (not shown). A network adapter 318 enables the system to become coupled to other systems or devices through intervening private or public networks 320. The system includes an operating system 322 and one or more application programs and utilities 324.

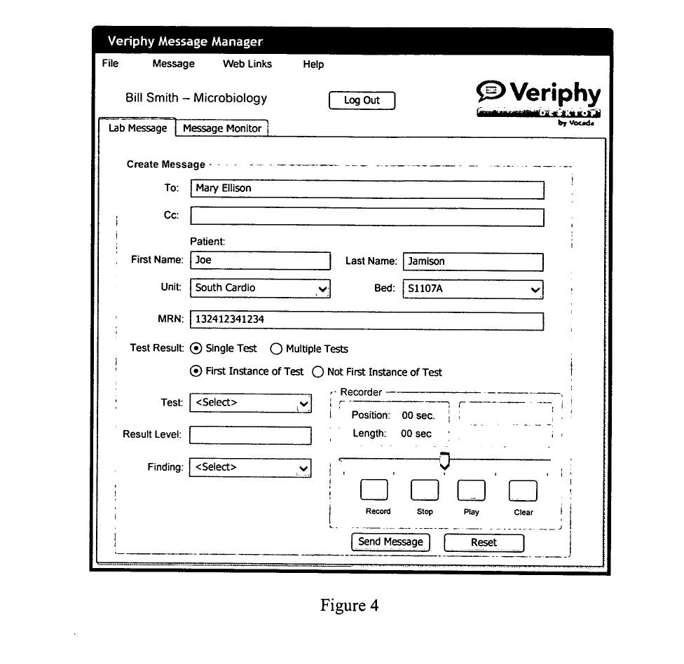

In use, and with reference to FIG. 4, an RC (or other permitted entity) launches an application and preferably creates the laboratory results message by entering text and voice information via the interface shown. The interface comprises one or more of the data entry fields described below:

### Fields

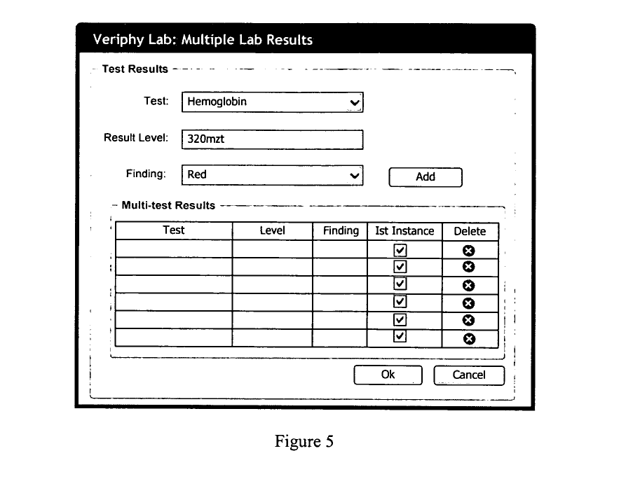

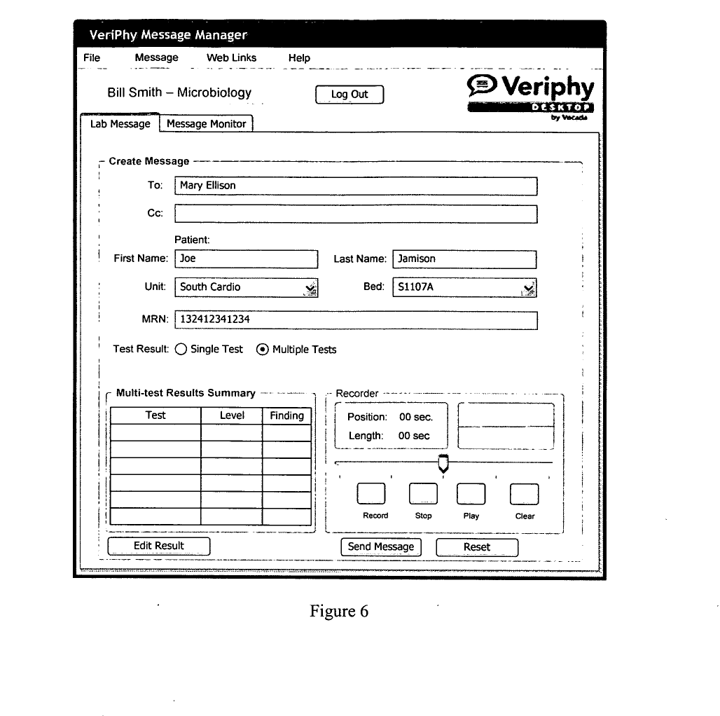

To: The list may also contain names of nursing stations or departments where a message may be sent from the lab. This is a required field, to be validated when the user tries to send a message.
Cc: (Same as above—allows the user to send message to a secondary recipient.)
(Patient) First Name:—Text-only field that allows the user to enter the first name of the patient. Required field.
(Patient) Last Name:—Text-only field that allows the user to enter the first name of the patient. Required field.
Unit: A combination box that allows the user to select the unit where the patient is located. The list preferably is populated from the database list of units defined for the current hospital. The Reporting Clinician will be associated with the current hospital so the login will indicate the hospital unit data to pull.
Bed Number: A combination box that is populated with those beds numbers (which may be a combination of number and identifying characteristics—user definable) linked to the selected Unit.
MRN: Allows the user to enter a numeric value indicating the medical record number associated with the patient.
Test Result: Two radio buttons that allow the user to say whether he or she is entering a single result or multiple results in the same message. If “Single” is selected, the screen does not change and the user can enter the results directly on the current screen. (Note: If “Multiple” is selected, then a popup window is displayed (see FIG. 5 below) and when the popup is closed, the screen contains a summary pane of test results (see FIG. 6 below), instead of the fields available for a single test result.)
First Instance of Test and Not First Instance of Test: Two radio buttons that allow the user to tell the system whether this test result is from the first instance of giving the test, or whether the test was a follow-up test to previous test(s). By default, the First Instance radio button is selected.
Test: A combination box that allows the user to select the test that was done. The combination box preferably is populated from a database list of tests that are associated with the lab.
Result Level: Some tests have associated levels, in which case this is a combination box (based on which Test was selected). Other tests allow the user to enter a Level, in which case this is a text box.
Finding: A combination box with findings that tell the system the criticality or severity of the result that is being reported. The combination box preferably is populated from a list of findings stored in the database.
Recording Control: A control widget that enables the operator to record a voice note using standard control functions (e.g., Record, Stop, Play and Clear).

With reference to FIG. 4, the following is a typical use case for creation of a laboratory results message. The RC begins by selecting a Message tab. In response, the system displays the Create a Message tab page, as shown. The RC then uses the “To” field to select an Ordering Clinician (OC). In response, the system preferably uses a search capability to allow the RC to select OC and CC names. The RC then optionally uses CC field to enter a second recipient of the message. In response, the system populates the “Unit” combo box based on the units defined for the hospital in which the RC is working. The RC then selects the patient's unit and bed # using the combination boxes. Once the unit is selected, the Beds associated with that unit are populated in the Bed Number combination box. The RC then enters Patient Name and Medical Record Number (MRN). If the user clicks “Single” test result, then system does not alter the page. If the user selects “Multiple” a popup window is displayed such as shown in FIG. 5. The Multiple Results Use Case is described below. Referring back to FIG. 4, the RC uses the radio buttons and selects Single Test. In response, the system populates the combination box based on an Administrative (Admin) database list of Tests. The RC leaves “First Instance” checkbox checked by-default. The RC then uses the combination box to select the “Test.” In response, the system populates the Finding combination box, preferably from an Admin database list of findings. Then, the RC enters a result level based on the test; alternatively, the RC selects a result from a combination box with predefined levels (depending on the test selected and test definitions in the Admin database). The system saves in a data record the information that has been input in the data fields. If desired, the RC then clicks the “Record” button to record a message describing the results. In response, the system records the voice note. When finished, the RC clicks “Stop” to stop recording. The system stops recording and allows the user to review or add to the voice note. The RC then clicks the “Send Message” button to send the composite laboratory results message (the data and the voice note) to the identified OC, the CC's and, preferably, one or more nurses. In response, the system sends the message to a server that, in turn, sends the message to the OC, to any identified CC's, and either directly to a device associated with a shift nurse assigned to the patient (bed), and/or a charge nurse/nursing station phone. The message may also be sent to an alert engine executing on a computer in the nursing station.

In the Multiple Use case, the Message tab may include results from a plurality of tests. As noted above, when the Multiple Tests radio button is selected, a window such as shown in FIG. 5 is displayed. This interface includes the following representative fields for use by the RC:

### Fields

Test: Combination box with a list of all of the possible tests associated with the current lab. Once a test is selected the Result Level box is populated as a combination box, or the user can enter a level as text. The tests should be logically grouped as they are entered in the Admin database.
Result Level: A text box or combination box with a list of predefined result level ranges for the currently selected test.
Finding: A combination box with a list of predefined findings.
Add: A button that allows the user to take the details of a result and move the details into the grid for easy viewing and deleting. When the Add button is clicked, preferably the highlight is removed (the items can stay in the list) and the user can select another result.
Columns in Test Grid:
   Test: Shows the name of the test that was selected.
   Result Level: Shows the result level that was either entered or selected.
   Finding: Shows the finding associated with the test.
   1^{st} Instance: This column allows the user to check or uncheck the box directly in the grid indicating whether this is a new test or not. By default, all check boxes should be checked.
   Delete: A button in each row that allows the user to delete (void) the entire row of information.
   OK: A button that stores the current information and closes the popup.
   Cancel: A button that cancels whatever changes were made to the information that existed in the window prior to opening it. If it was all new information, then that information is discarded. If it is changed information, then those changes are discarded.

Once the popup window (or equivalent display panel) is populated and closed, the Message tab is displayed as shown in FIG. 6. As compared to FIG. 4, it can be seen that the tab now includes a Multi-test Results Summary table in which the information entered in the popup window of FIG. 5 is displayed. In the Multiple Test case, each test can have a different finding within the same message, but preferably the single laboratory results message that is created (and forwarded to the OC, CCs and nurse) takes on the most critical finding that is attached to any of the tests. For example, if three of the results are yellow and one is red (where red is the most critical), then preferably the entire message becomes a Red message.

One of ordinary skill in the art will appreciate that the display layout and input fields and controls described in FIGS. 4-6 are merely representative. Typically, the severity of the laboratory finding is identified using a “red, orange, or yellow” classification system, which associates various numerical values with the severity level, but this is not a requirement. Moreover, although not illustrated, the TO and CC fields may have associated drop-down lists that are populated with one or more identifiers for the ordering physicians, nurses and other entities that are to be provided with the test result data. Of course, access to the VUI in general or to one or more groups of named individuals (e.g., via the drop-down lists) may be restricted or inhibited to authorized clinicians using known authentication and/or authorization techniques. As noted above, when the message entry is complete, the clinician clicks the Send Message button and the resulting laboratory results message is sent to the Web Service API 212 in FIG. 2. The Web Service API consumes the message and preferably provides back an acknowledgement.

Although not a limitation, in the embodiment in which voice interactions are used, preferably the laboratory results message is maintained in the hosted service as a computer-generated set of discrete pre-recorded components. Thus, for example, a library of numbers, words and phrases (e.g., “1,” “2,” “3,” “high,” “low,” “potassium,” “sodium,” “ml equivalents” and so on) are preferably pre-recorded and saved in the system. When the message recipient contacts the system, control routines retrieve the pre-recorded elements and concatenate them together to compose the required message, which is then played. One or more of the message components (such as the patient's name) may be generated via text-to-speech processing, but this is not a requirement.

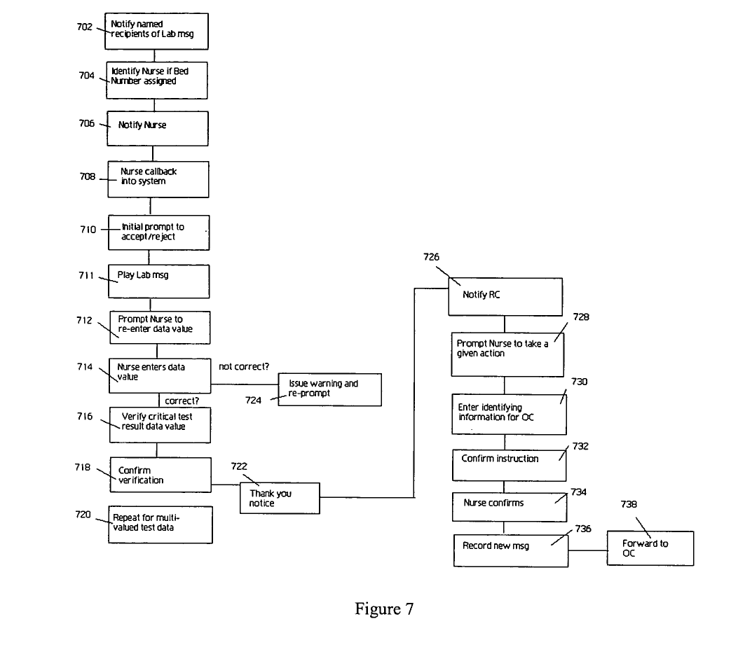

In a representative (but non-limiting) embodiment, and as noted above, the system preferably sends messages to one or more members of a nursing staff in addition to the ordering clinicians. A representative message delivery and forwarding workflow is now described and illustrated by the process diagram in FIG. 7. The workflow begins with step 702. At this step, the system notifies any named recipients in the TO and CC fields. At step 704, the system identifies a Nurse if a Bed Number (see the display tab in FIG. 4) has been assigned. Although any convenient technique may be used, preferably the system determines the identity of the Nurse using information retrieved from the Admin database. Thus, for example, typically the RC belongs to an identified Group and has a set association with an OC. A Nurse belongs to an identified Directory, and a Directory belongs to a Group. The RC is also associated with a Group. A Nurse to Bed assignment leads to an association of Bed Numbers to RC. Thus, if the RC and Bed Number are known, the Nurse can be identified. Referring back to FIG. 7, if a Nurse has been associated (e.g., in a Nurse profile) with a phone number and the appropriate bed, preferably a real-time, outbound phone call is made to the Nurse to inform him/her of the critical test result. In the alternative, if a Nurse has been assigned to the bed but has no phone number, then a text message or the like is sent to the Nurse. In either case, this function is identified as step 706. The notification to the Nurse includes callback or other instructions for how to retrieve the laboratory results message. If no Nurse is assigned to the bed, the RC receives an error message and may be restricted from sending the message, but this is not a requirement. At step 708, the Nurse calls back into the system and is prompted to enter a given access code (typically the code that is provided in the callback instructions). At step 710, the system provides an aural notice, e.g., “You have a critical lab value, say accept or reject” or “You have multiple Lab Values, say accept or decline” if there are multiple values for a particular patient. If accepted, the system continues at step 711 to play the laboratory results message, e.g., “Patient Joe Smith, MRN 12345, in Bed 4A has High Potassium. Potassium Level is 7 mEq/L.” At step 712, the system prompts the Nurse to verify the critical test result data value, e.g., “Please verify Potassium Level.” At step 714, the Nurse enters a data value (in this example, “7”) on a data entry device (e.g., a numeric keypad) or speaks a response (which can be recognized by a suitable voice recognition subsystem). At step 716, the system verifies that the critical test result data value that was presented to the Nurse has been re-entered by the Nurse correctly. A timeout for receipt of the response may be enforced if desired. If the Nurse has re-entered the data value of the test, at step 718 the system provides a verification message, e.g., “Lab Value Verified.” Alternatively, the system can issue an audible tone that indicates success. If the patient has multiple values, the system adds “Next value is . . . ,” and so forth until all values have been presented and verified. This is step 720. At the end of the initial acceptance process, the system issues a termination notice, e.g., “Thank you.” This is step 722.

If (at step 714) the Nurse enters an incorrect lab value, an audible warning sounds at step 724 and the system prompts the Nurse, e.g., “Incorrect Value. The Potassium value is 7 mEq/L. Please verify Potassium level.” Control then returns to step 716.

If the nurse rejects the original message, the system queries the Nurse and captures and response information and forwards it to the RC.

After the Nurse has verified the Finding value, the RC that created the laboratory test message is notified at step 726. This notification may be through any convenient communication mechanism (e.g., phone, email, SMS, MMS, fax, desktop alert, PDA alert, laptop alert, or the like) as identified in an RC Profile maintained in the Admin database. In addition, the Nurse then is prompted to take a given action with respect to the Finding value. In particular, after the system states “Lab Value Verified” or the like (at step 718), the Nurse is prompted with a set of alternatives at step 728, such as: “Startover, Forward, or Simply hangup.” If the Nurse says “Forward,” at step 730 he or she is prompted to select a First and Last name (or other identifier) of an ordering physician or other person/entity. A voice recognition subsystem or equivalent may be used to identify the spoken input; alternatively, the Nurse can send the forwarding information using any other convenient technique such as SMS, email, fax, or the like. After selecting a name, the system issues a prompt at step 732, e.g., “Are you sure you want to forward this lab result to Dr. Joe Smith.” If so, at step 734, the Nurse responds affirmatively and the system provides a prompt to this effect, e.g., “Please leave message at the tone.” At step 736, the Nurse creates a voice message; the OC or other physician is then notified via the system's directory settings. This is step 738. In the alternative, the Nurse uses a voice entry interface such as described above and creates a new laboratory results message (or a supplement to the initial message). This completes the process.

Although not illustrated in detail, preferably all messages that are not retrieved within a specified time period follow settable escalation rules. Moreover, preferably all read-back discrepancies are immediately sent to the reporting clinician, the reporting department, and to a hospital patient safety coordinator. Dynamic and periodic reports can be generated to determine read-back, reporting, and turnaround time compliance.

Thus, according to the invention, an initial recipient of the clinical test result data value is prompted to verify the test results that he or she has just heard or seen to confirm receipt of such results, as well as confirmation that the information provided was properly understood. The read back function ensures that the actual communication of complete clinical information (including, without limitation, a critical tests result) occurs in a seamless, real-time manner.

The workflow illustrated in FIG. 7 is not meant to be taken to limit the present invention. It is not required that the lab message be sent to the Nurse prior to being sent to the OC; this path, however, is quite useful in the clinical or hospital setting where the patient has been assigned to a bed for which the Nurse is directly or indirectly responsible. As can be seen, the present invention enables pathologists, laboratory technicians, and laboratory staff to communicate lab or other results to ordering nurses and physicians in real-time using a fully traceable and verifiable communication system

As previously noted, the hardware and software systems in which the invention is implemented are merely representative. The invention may be practiced, typically in software, on one or more machines. Generalizing, a machine typically comprises commodity hardware and software, storage (e.g., disks, disk arrays, and the like) and memory (RAM, ROM, and the like). The particular machines used in the network are not a limitation of the present invention. A given machine includes network interfaces and software to connect the machine to a network in the usual manner. As illustrated in FIG. 1, the present invention may be implemented as a managed service (e.g., in an ASP model) using the illustrated set of machines, which are connected or connectable to one or more networks. More generally, the service is provided by an operator using a set of one or more computing-related entities (systems, machines, processes, programs, libraries, functions, or the like) that together facilitate or provide the inventive functionality described above. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, NET), and a set of applications or processes (e.g., Java applets or servlets, linkable libraries, native code, or the like, depending on platform), that provide the functionality of a given system or subsystem. As described, the service may be implemented in a standalone server, or across a distributed set of machines. Typically, a server connects to the publicly-routable Internet, a corporate intranet, a private network, or any combination thereof, depending on the desired implementation environment.

As used herein, a “clinical test” should be broadly construed to cover a test, a study, an investigation, or a combination thereof.

As used herein, the “result” of a clinical test should be broadly construed to cover a data value, a positive or negative indication, an attribute associated with a given test, or a combination thereof. Also, a “result” may be a composite or set of information or data, and thus a “result” may include all or some portion thereof.

As used herein, an “entity” should be broadly construed to cover a person, a device, an apparatus, a system, a computer, a program, an automated process, or any combination thereof. In this regard, a clinical results message may be generated by a test apparatus, a computer system, or the like, and it is not required that the entity comprise part of the hosted or managed service.

Having described our invention, what we now claim is set forth below.

1. A method for communicating given clinical information, comprising:
having a first entity generate a message comprising a result associated with a given clinical test;
providing a second entity the message including a test attribute, the result associated with the test attribute, and a prompt to enter the result;
upon confirmation that the second entity has provided the result, notifying the first entity that the second entity has received and understood the result.

2. The method as described in claim 1 wherein the given further action is forwarding at least the result in the message to a third entity.

3. The method as described in claim 2 wherein the first entity is a reporting clinician, the second entity is a nurse, and the third entity is an ordering clinician.

4. The method as described in claim 1 further including providing the second entity a given notification that the message is available for retrieval from the hosted service prior to providing the second entity the message.

5. The method as described in claim 4 wherein the first entity is notified by one of: e-mail, SMS, MMS, page, fax and computer-based alert.

6. The method as described in claim 1 wherein the message includes a voice note created by the first entity.

7. The method as described in claim 3 wherein the clinical test is requested by the third entity.

8. The method as described in claim 1 further including identifying the second entity from a set of second entities.

9. The method as described in claim 1 wherein the message includes a second test attribute and a result associated with the second test attribute.

10. The method as described in claim 9 wherein the second entity also is provided the second test attribute, the result associated with the second test attribute, and a prompt to enter the result associated with the second test attribute.

11. The method as described in claim 1 wherein the message comprises a combination of one or discrete recorded elements.

12. A method for communicating given clinical test result data, comprising:
providing a receiving entity a voice message including a test attribute, a result associated with the test attribute, and a prompt to enter the result;
upon confirmation that the receiving entity has provided the result, notifying an entity that created the voice message that the receiving entity has received and understood the result, and prompting the receiving entity to determine whether the result is to be forwarded; and
upon confirmation that the result is to be forwarded, forwarding at least the result to another entity.

13. A computer-readable medium having computer-executable instructions for performing the method steps of claim 12.

14. A server comprising a processor, and a computer-readable medium, the computer-readable medium having processor-executable instructions for performing the method steps of claim 12.

15. In a computer system that provides a hosted service, a method for communicating given clinical information, comprising:
having a laboratory clinician generate a message comprising a result associated with a given clinical test;
providing a nurse with a notification concerning the message;
in response to receipt of an access request from the nurse, providing the message to the nurse including a test attribute, a result associated with the test attribute, and a prompt to enter the result;
upon confirmation that the nurse has provided the result, notifying the laboratory clinician that the nurse has received and understood the result;
providing the nurse an option to forward the message to an ordering clinician;
determining if the message is to be forwarded; and
if so, forwarding the message to the ordering clinician.
